(19) United States
(12) Patent Application Publication
(10) Pub. No.: US 2009/0285002 A1
(43) Pub. Date: Nov. 19, 2009

(54) MAINS CONVERTER FOR SWITCHING, WITHOUT ANY INTERRUPTION, BETWEEN CLOCKED VOLTAGE-REGULATED OPERATION AND FUNDAMENTAL-FREQUENCY UNREGULATED OPERATION, AND METHOD FOR SWITCHING A CONVERTER SUCH AS THIS WITHOUT ANY INTERRUPTION

(75) Inventors: Norbert Benesch, Heroldsberg (DE); Bernd Köhler, Murrysville, PA (US)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/305,535

(22) PCT Filed: Feb. 23, 2007
(86) PCT No.: PCT/EP2007/051746

§ 371 Date: Dec. 18, 2008

(30) Foreign Application Priority Data
Jun. 19, 2006 (DE) 10 2006 028 103.9

(51) Int. Cl. H02M 7/219

(52) U.S. Cl. 363/127

(57) ABSTRACT

A current source inverter is disclosed, comprising: means for operating the inverter in fundamental frequency unregulated operation, means for operating the inverter in clocked voltage regulated operation, means for recording parameters from which conclusions can be drawn at an instantaneous operating point and/or at an instantaneous network condition, means for determining an appropriate operating condition from the recorded parameters and means for uninterrupted switching of the operation of the inverter to the operating condition as determined from the recorded parameters and a method for uninterrupted switching of such a current source inverter.

The invention relates to a mains converter as claimed in the preamble of claim 1, and to a method as claimed in the preamble of claim 6.

Electrical installations, for example those which, from the view of the three-phase mains system, operate as loads at times and as generator at times, are normally connected to the three-phase mains system via a so-called intermediate circuit. One example of an electrical installation such as this is a centrifuge in a sugar factory. In particular, installations which are operated only at times for local electricity power generation, such as relatively small wind-power or solar installations, are likewise connected to the three-phase mains system via an intermediate circuit.

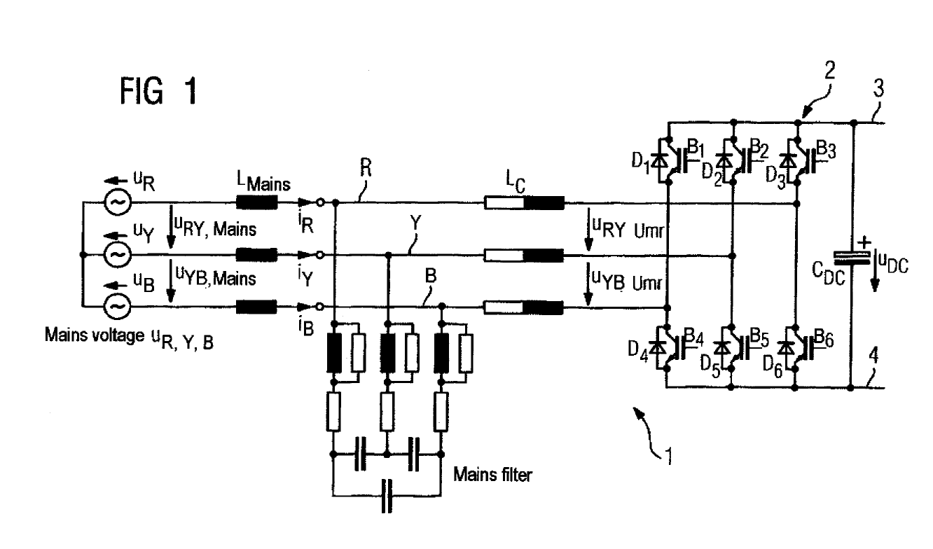

FIG. 1 uses a sketch to show the known design and connection of a converter 1 in the form of a step-up controller for operation of an intermediate circuit 2 to a three-phase mains system 3. The converter 1 comprises a plurality of semiconductor switches T1, . . . , T6 which, for example, are in the form of transistors or thyristors and are each arranged between a line R, Y, B of the three-phase mains system 3 and a line 4, 5 of the intermediate circuit 2. The lines R, Y, B of the three-phase mains system are also referred to as phases R, Y, B. The arrangement of the six semiconductor switches T₁, . . . , T₆ illustrated in FIG. 1 is referred to as a six-pulse bridge circuit, or B6 bridge for short. The expression three-phase is also normally used instead of the expression six-pulse. An intermediate-circuit voltage u_{DC} exists in the intermediate circuit 2. The intermediate-circuit voltage u_{DC} is a DC voltage. An intermediate-circuit capacitance C_{DC} is arranged between the lines 4, 5 of different electrical potential, for buffering and smoothing of the DC voltage. Commutation inductors L_{C} are arranged in the individual lines R, Y, B between the three-phase mains system 3 and the intermediate circuit 2.

The switching flanks of the semiconductor switches in the fundamental-frequency unregulated mode occur at the natural triggering times, that is to say the intersections of the mains voltages u_{R, Y, B} of the individual lines R, Y, B of the three-phase mains system 2.

The expression fundamental-frequency clocking comprises clocking of the individual semiconductor switches in a manner such that they are each driven in their individual angle ranges, segments or the like, as provided during the fundamental-frequency clocking, permanently, for example by driving them with a direct-current switching signal, or at least predominantly, for example by driving them with a radio-frequency switching signal.

Fundamental-frequency unregulated operation of converters is distinguished by a number of advantages which make their use worthwhile. Since there is no radio-frequency clocking of the semiconductor switches, which can also be referred to as current valves, this results, for example, in low switching losses and therefore in reduced thermal loading of the converter, of the inductor and of the mains filter. It is also possible to use simple and low-cost commutation inductors and mains filters. In addition, there is little excitation of system oscillations in the intermediate circuit with respect to ground which, for example, can lead to high motor bearing currents. This also results in a rectifier behavior, with the intermediate-circuit voltage being lower than in the case of step-up controller operation of an active converter.

A relatively low intermediate-circuit voltage maximum value can thus be maintained in the event of a temporary rise in the mains voltage, thus achieving a reduced load on the motor insulation, for example when an inverter and motor are connected to the intermediate circuit.

In the same way as the step-up controller mode, the fundamental-frequency mode described here allows a power flow or energy flow from the mains system to the intermediate circuit, and vice versa. One considerable disadvantage of the fundamental-frequency unregulated mode is, however, that, when the mains voltage falls or power is drawn from the intermediate circuit, the intermediate-circuit voltage decreases and the other components in the intermediate circuit no longer operate at the optimum operating point. By way of example, a motor can no longer produce its maximum power when the intermediate-circuit voltage falls.

Furthermore, active converters are known which are operated in the so-called clocked voltage-regulated step-up controller mode.

By way of example, the transistors are driven on a pulse-width modulated basis using the space-vector modulation that is described in detail in the specialist literature. One advantage of the clocked voltage-regulated mode is a regulated intermediate-circuit voltage, in which case a set value, which is also time-variant if required, is maintained for the intermediate-circuit voltage even in the event of mains voltage fluctuations and load fluctuations. One precondition for the continuous step-up controller mode is that:

u_{DC.regulated}>\sqrt{2}·u_{mains.eff}

A further advantage of the clocked voltage-regulated mode is that, in the event of a disturbance of operation, for example mains disturbance or load shedding, the intermediate-circuit voltage can be returned to its set value again in a controlled manner.

Furthermore, a sinusoidal mains current is possible, that is to say a power factor of cos φ≈1 can be achieved, in which case there is no reactive-power load on the mains system or the converter components.

A further advantage of the clocked voltage-regulated mode is that it is possible to compensate for the mains reactive power.

Furthermore, a model-based current and voltage regulation without any transmitters is possible.

A further advantage of the clocked voltage-regulated mode is that simple and precise identification of specific physical variables is possible, for example determination of the inductance of the mains system and of the inductor, or for the intermediate-circuit capacitance.

Furthermore, automatic fault identification and system diagnosis are possible by comparison of model and sensor data, for example identification of defective current and/or voltage detections or identification of capacitance changes.

One of the two functional principles may be more suitable temporarily, depending on changing applications and depending on the operating point and the mains conditions. However, until now, only one of the two operating modes has been implemented in a converter. It has accordingly not been possible to use the specific advantages of the operating modes without process interruption.

However, when the operating states of loads or generators which are connected to an intermediate circuit vary over time and when the mains conditions vary over time, switching between the operating modes without any interruption is required, without any interruption in the power flow, in particular without any disadvantageous effects on the components connected to the intermediate circuit. By way of example, this must not lead to overvoltages or undervoltages in the intermediate circuit, or to mains overcurrents.

One object of the invention can therefore be considered to be to specify a mains converter by means of which it is possible to switch, preferably without any interruption, between fundamental-frequency unregulated and clocked voltage-regulated operation, and to specify a method by means of which a converter can be switched without any interruption between fundamental-frequency unregulated and clocked voltage-regulated operation.

The first part of the object is achieved by the features of claim 1, and the second part by the features of claim 6.

The invention proposes switching without any interruption, and possibly automatically, between the two operating modes.

For this purpose, the converter according to the invention preferably has:
a converter topology which allows both operating modes, for example an IGBT-B6 bridge,
circuit components which are suitable for both operating modes,
control hardware and/or control software for both operating modes, such as an ASIC (application-specific integrated circuit) drive unit for both operating modes switchable by register configuration, wherein the configuration register, preferably in the ASIC, is read or latched together with the other control registers, or the pulses are blocked for switching for one sampling clock cycle (since one sampling clock cycle is short in comparison to the system time constants, this switching can also be referred to as being without any interruption),
a hardware/software design which allows switching during operation, for example by the capability to change the drive unit operating mode by register access during operation, by a system sequence controller with access and regulator initialization routines for on-the-fly activation of the respective other operating mode,
a sensor system and/or predetermined criteria for automatic switching between the operating modes.

The virtually simultaneous availability of the two operating modes in one converter results in a new quality, since it is possible to cope with system states such as mains overvoltage or undervoltage, without process interruption.

In the case of a converter according to the invention, the combination of the advantageous characteristics of the two operating modes results in:
an extension of the permissible mains voltage range in the event of voltage fluctuations during operation,
a power extension of the converter by reducing the thermal load or by reducing the reactive power,
a functional extension of the fundamental-frequency operating mode by power factor correction as required,
increased reliability as a result of the capability for further operation in the event of transmitter failure,
a capability to avoid disturbances in operation caused by system oscillations, and
a capability to identify specific physical variables of the converter, such as filter time constants and the like, and for system diagnosis in the fundamental-frequency mode, as well.

In summary, this results for the mains converter according to the invention in a power extension in the event of temporary overload states, an extended range of application in the event of mains fluctuations and when reactive power is required, and a capability to increase the robustness and to improve system diagnosis.

The invention will be explained in the following text with reference to the drawings, in which:

FIG. 1 shows a schematic illustration of a mains IGBT converter with commutation inductor and mains filter on the three-phase mains system,

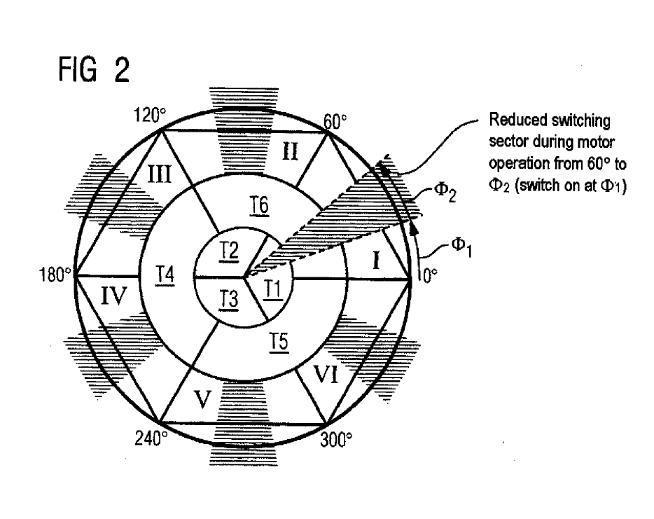

FIG. 2 shows a switching pattern according to the invention for driving the semiconductor switches in the converter illustrated in FIG. 1,

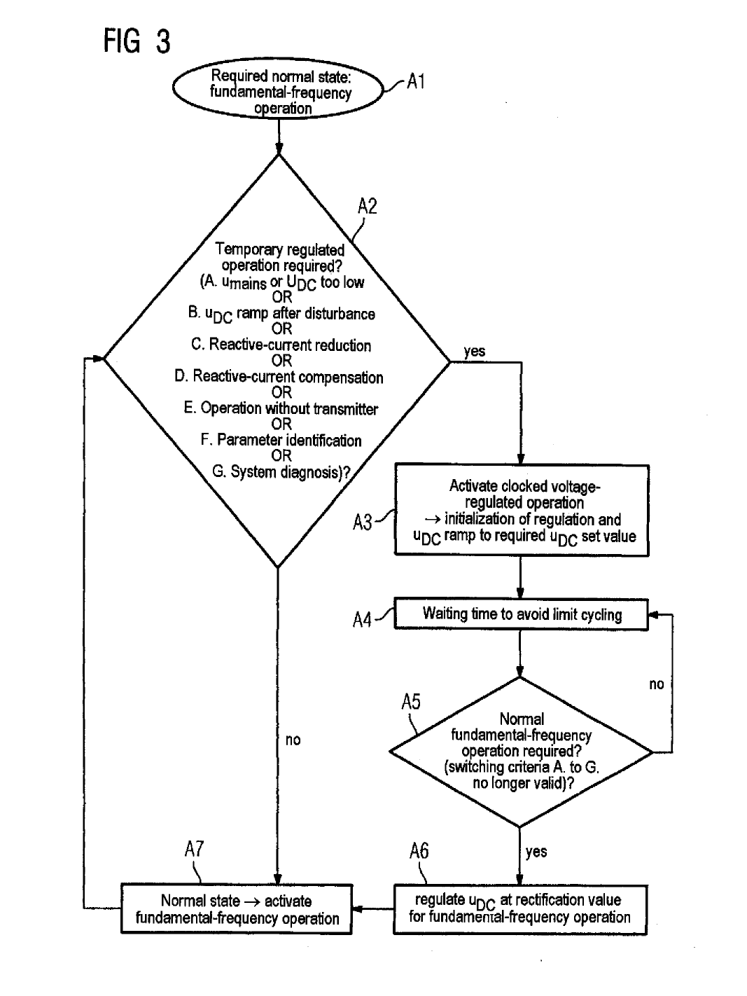

FIG. 3 shows a flowchart of a method according to the invention for temporarily changing from fundamental-frequency operation to voltage-regulated operation during operation,

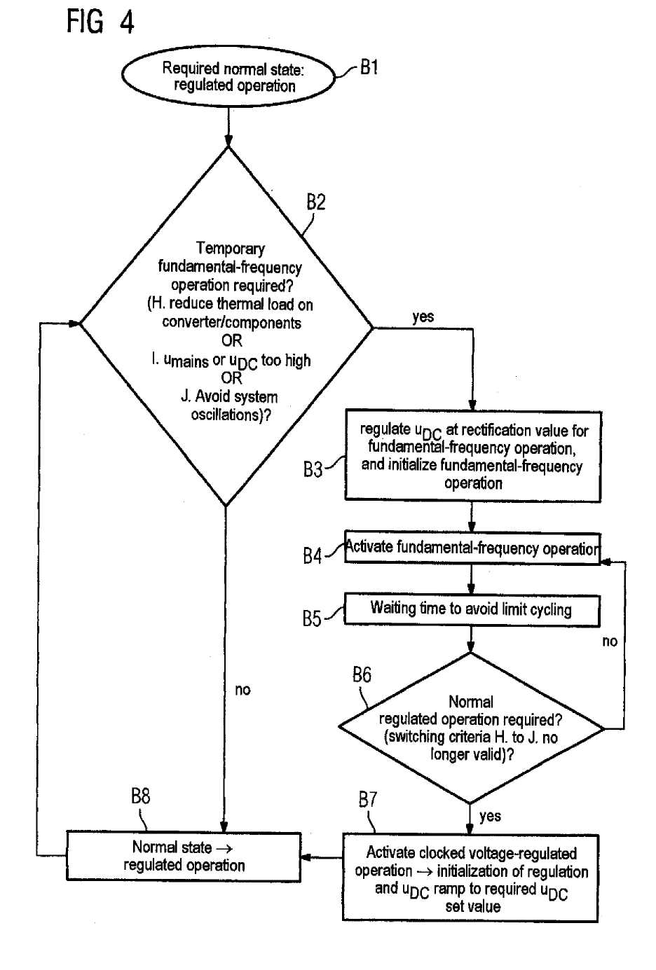

FIG. 4 shows a flowchart of a method according to the invention for temporarily changing from voltage-regulated operation to fundamental-frequency operation during operation,

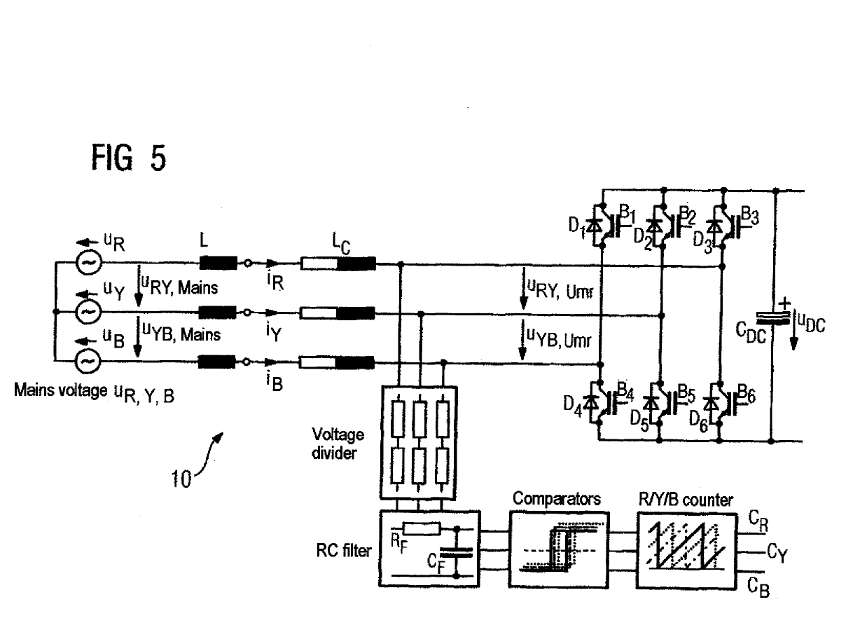

FIG. 5 shows a schematic illustration of a circuit diagram of a converter on the three-phase mains system with a signal flow plan in order to determine the mains angle,

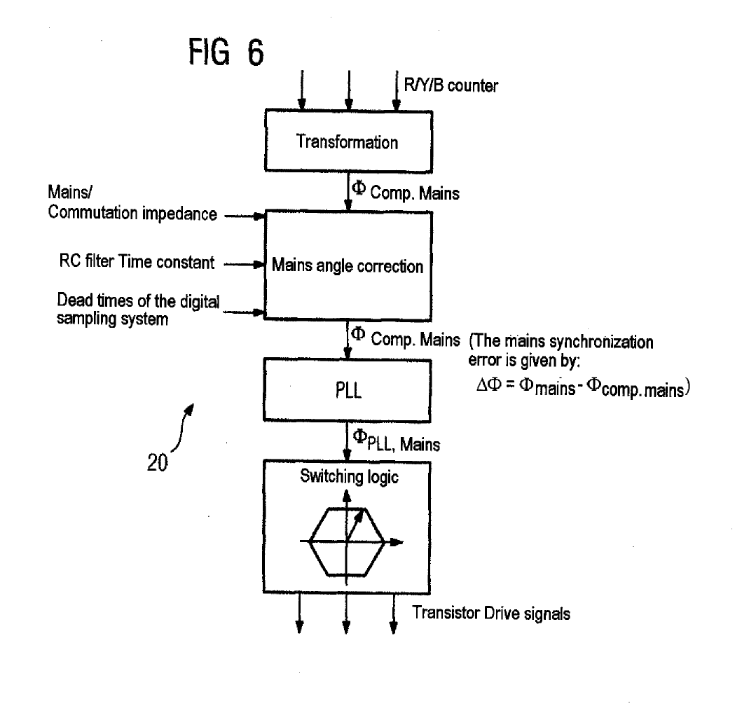

FIG. 6 shows a schematic illustration of a mains angle correction for calculation of the transistor drive signals from the zero-crossing counters,

FIG. 7 shows a diagram which illustrates the time profile of the phase currents ΔΦ=0° and ΔΦ=−5° in the case of a motor load,

FIG. 8 shows a diagram which illustrates the time profile of the phase currents ΔΦ=0° and ΔΦ=+50 in the case of a generator load,

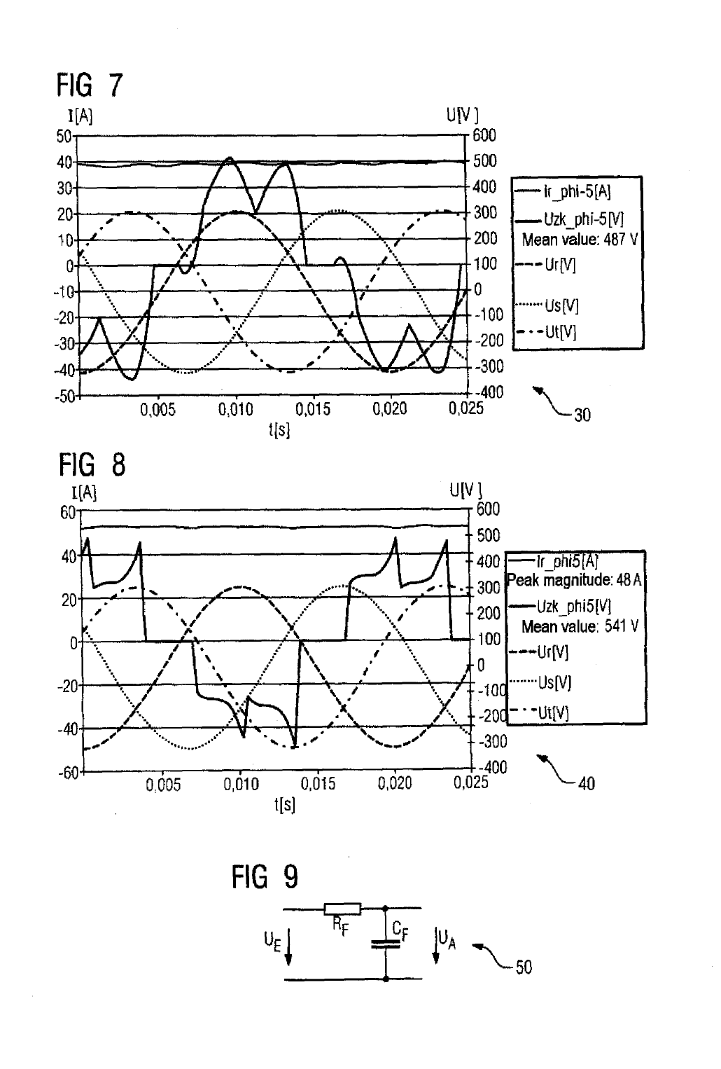

FIG. 9 shows a circuit diagram of an RC element,

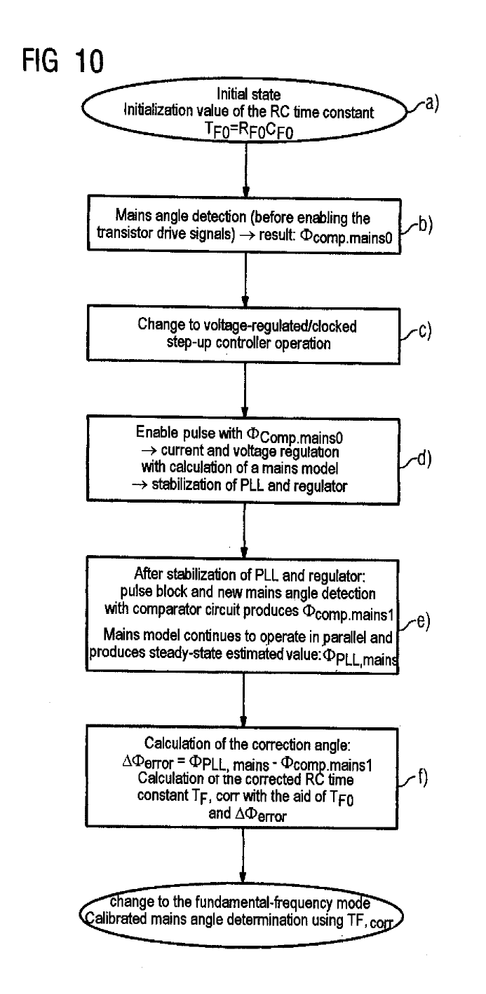

FIG. 10 shows a flowchart for automatic determination of the filter time constant T_{F,corr} of a converter according to the invention,

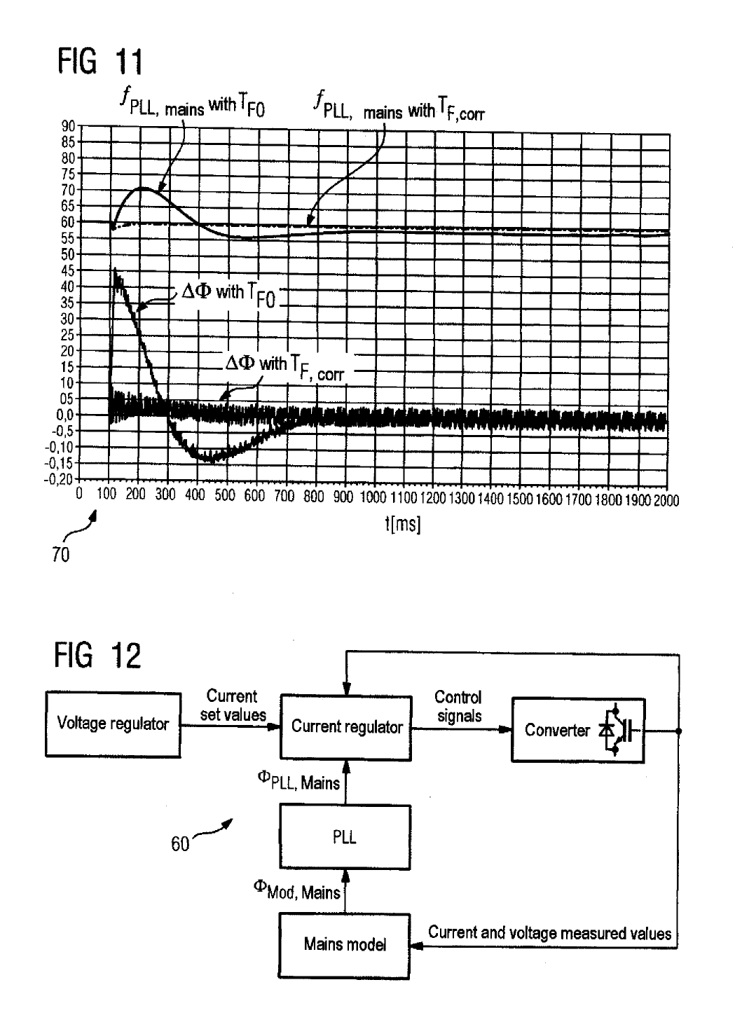

FIG. 11 shows a diagram illustrating the transient response of the mains model before and after adaptation of the time constants for the zero-crossing filter, and

FIG. 12 shows a structural sketch illustrating how the phase locked loop (PLL) and mains model are linked in the regulated step-up controller mode.

FIG. 2 shows the control logic of the semiconductor switches T₁ to T₆ in the fundamental-frequency clocked mode for one mains period, from 0° to 360°. In this case, “fundamental frequency” means that the individual angle ranges of the semiconductor switches T₁ to T₆ are driven permanently, for example by driving using a direct-current switching signal, or at least predominantly, for example by driving using a radio-frequency switching signal.

One semiconductor switch T₁, T₂, T₃, T₄, T₅, T₆ is in each case normally switched off at the boundaries of the 60° sectors I, II, III, IV, V, VI of the mains angle Φ, and one other semiconductor switch T₁, T₂, T₃, T₄, T₅, T₆ is switched on. A further semiconductor switch T₁, T₂, T₃, T₄, T₅, T₆ is still driven at the respective boundary between the sectors I, II, III, IV, V, VI, and all the other semiconductor switches T₁, T₂, T₃, T₄, T₅, T₆ are open. The closing of the semiconductor switches T₁, T₂, T₃, T₄, T₅, T₆ can now be shifted through the angle Φ₁ in each sector I, II, III, IV, V, VI, shown for the sector I in FIG. 2, and shortened to the angle range Φ₂. The semiconductor switches T₁, T₂, T₃, T₄, T₅, T₆ are then each driven only in the shaded segments. At all other times or mains angles, all the semiconductor switches T₁, T₂, T₃, T₄, T₅, T₆ are open, resulting in the behavior of a pure diode bridge.

Starting from the normal state in each case, FIGS. 3 and 4 show a flowchart illustrating the switching according to the invention between the operating modes.

In the flowchart shown in FIG. 3, a converter according to the invention is in the normal state, in the fundamental-frequency unregulated mode (step A1). Detection of the instantaneous operating state of the converter, that is to say detection or finding whether the operating state of the converter is the fundamental-frequency unregulated mode or the clocked, voltage-regulated mode at that instant, is in this case carried out by finding whether or not the converter is in the normal state.

In a further step A2, parameters are detected from which it is possible to deduce an instantaneous operating point and/or the instantaneous mains conditions, and from which it is also possible to deduce whether or not the instantaneous operating state is suitable for the instantaneous power requirements. By way of example, these parameters are the mains and/or intermediate-circuit voltage. If one of the two is too low, the fundamental-frequency mode is not a suitable operating state. It is likewise possible to determine whether or not a disturbance has occurred and whether or not the intermediate-circuit voltage should be raised along a ramp. Furthermore, the reactive current can be detected. If this is too high, the fundamental-frequency unregulated mode is likewise temporarily not a suitable operating state. Further criteria may be operation without transmitters, identification, which is referred to as parameter identification, of physical variables such as filter time constants of the converter according to the invention, or a system diagnosis. The fundamental-frequency unregulated mode is not a suitable operating state in any of these cases.

The detected parameters are likewise used in step A2 to determine whether or not the instantaneous fundamental-frequency unregulated operating mode is suitable for the instantaneous power requirements.

If this is not the case, then, in a third step A3, the clocked voltage-regulated mode is activated, with the regulation being initialized and with the intermediate-circuit voltage being raised along a ramp to a desired set value.

An intermediate step A4 comprises a waiting time in order to avoid limit cycling. This is used, for example when the power requirements vary with little notice, to avoid continual switching between the operating states of the converter.

A check is then carded out in a fifth step A5 to determine whether or not the original switching criteria are still satisfied. If the criteria are still satisfied, the method continues with step A4. If the criteria are no longer satisfied, the operating state is changed back to the fundamental-frequency unregulated mode.

This is done by first of all regulating the intermediate-circuit voltage, in a step A6, at a rectifier value for the fundamental-frequency unregulated mode.

In a seventh step A7, the normal state is then reached again by activation of the fundamental-frequency unregulated mode.

The method continues by once again checking in step A2 whether or not the criteria for switching to the voltage-regulated clocked mode are satisfied again. If the criteria are not satisfied, the method steps A2 and A7 form a repeating loop.

The method according to the invention as illustrated in FIG. 4 differs from that in FIG. 3 essentially in that the converter is in the voltage-regulated clocked mode during normal operation.

Starting from a normal state in the voltage-regulated clocked mode (step B1), parameters are detected in step B2 which could make it necessary to temporarily switch to the fundamental-frequency unregulated mode. The parameters are, for example, the instantaneous thermal load on the converter, an excessively high mains and/or intermediate-circuit voltage, or the necessity to avoid system oscillations which may occur in the voltage-regulated clocked mode.

If one or more criteria is or are satisfied, a decision is made in step B2 that the voltage-regulated clocked mode is not a suitable operating state, and the method is continued with step B3. If none of the criteria are satisfied, the voltage-regulated clocked mode is the suitable operating state, and the method is continued with step B8.

In step B3, the intermediate-circuit voltage is regulated at a rectifier value for the fundamental-frequency unregulated mode, and the fundamental-frequency unregulated mode is then activated in step B4.

For the reasons already mentioned above, this is followed by an intermediate step B5 which comprises a waiting time in order to avoid limit cycling.

A check is carried out in step B6 to determine whether the criteria for switching from the voltage-regulated clocked mode to the fundamental-frequency unregulated mode are still satisfied. If the criteria are still satisfied, the method continues with step B5. If the criteria are no longer satisfied, the method continues with step B7.

In step B7, the clocked voltage-regulated mode is activated, with the regulation being initialized and the intermediate-circuit voltage being raised along a ramp to a desired set value.

The normal state in the voltage-regulated clocked mode is then reached once again in step B8.

The method continues by once again checking in step B2 whether or not the criteria for switching to the fundamental-frequency unregulated mode are satisfied again. If the criteria are not satisfied, method steps B2 and B8 form a repeating loop.

In order to allow the two methods according to the invention as described above to be carried out, a mains converter according to the invention has:
means for operation of the converter in the fundamental-frequency unregulated mode,
means for operation of the converter in the clocked, voltage-regulated mode,
means for detection of parameters from which it is possible to deduce an instantaneous operating point and/or instantaneous mains conditions, for example sensors, current or voltage measurement apparatuses or the like,
means for determining a suitable operating state on the basis of the detected parameters, and
means for switching the operation of the converter, without any interruption, to the suitable operating state determined on the basis of the detected parameters.

Important factors are that the switching takes place during operation and that the switching process must not disadvantageously influence either the mains or the load on the intermediate circuit. For this purpose, the switching processes are carried out without any interruption, or the interruption duration is short in comparison to the relevant time constants on the mains side and DC voltage side. The stated criteria can be used as the basis for automatic switching between the operating modes as a function of the environmental conditions, the load requirement or the user requirements.

FIGS. 5 to 12 show one exemplary embodiment for use of the operating mode switch according to the invention for automatic determination of filter time constants in the mains synchronization circuit of a mains converter.

FIG. 5 shows a sketch of the connection and configuration of a converter 10, which will be considered in the following text. The transistor-switching flanks for the fundamental-frequency mode occur at the natural triggering times, that is to say the intersections of the sinusoidal mains voltages u_{R, Y, B}.

In order to produce the transistor drive signals using the circuit 20 illustrated in FIG. 6, it is necessary to know the instantaneous phase angle Φₘₐᵢₙₛ of the balanced three-phase source u_{R, Y, B} Voltage detection in the converter, and not on the mains side of the external commutation inductor as is normal practice in the prior art, avoids additional wiring complexity and external sensor systems. However, u_{RYB, Umr} are in general not sinusoidal and have commutation notches. The difference voltages must therefore be filtered, for example by means of RC filter elements, in order to determine the mains angle. The amplitude information relating to the difference voltages u_{RYB, Umr} is not required for mains angle detection. Detection of the positive zero crossings of the three difference voltages with the aid of comparator circuits is sufficient. For example, a respectively associated counter is reset on a zero crossing of the filtered sinusoidal difference voltages and a defined change in mathematical sign. A phase angle Φ_{comp,Umr} can be determined unambiguously from the three counter values. The mains angle Φₘₐᵢₙₛ of the voltage source is required for the transistor drive. This angle can be determined approximately from Φ_{comp,Umr} provided that the mains and commutation impedances, the time constants of the RC voltage filters, and the dead times of the measured-data detection and of the digital sampling system are known. The corrected angle is referred to as Φ_{comp,mains} and is smoothed by a phase locked loop (PLL). The inductance values can be measured automatically in the course of section identification in the regulated clocked mode, the dead times are in general constant, and can be determined offline once. As a result of the component tolerances, which are typically in the region of about +−10%, the RC time constants are subject to a large amount of scatter and can be measured only with a relatively large amount of effort in the completely constructed circuit. Even minor discrepancies in the determined mains angle lead to significantly higher current maxima, however, and thus to a greater load on the semiconductor switches and to premature disconnection of the converter in the fundamental-frequency mode. Furthermore, during generator operation, the power factor deteriorates because of the phase shift between the voltage and the current.

FIG. 7 shows a diagram 30 illustrating one example of premature switching of the transistors with an undershoot of the phase current and thus a current load which rises overall and a reduced mean intermediate-circuit voltage.

The diagram 40 in FIG. 8 shows the effects of delayed driving of the semiconductor switches as a result of incorrect RC matching. The currents rise steeply at the end of the current blocks, and there is also a phase shift with respect to the mains voltage.

A method would therefore be advantageous by means of which the time constants of the voltage filters, and if appropriate the time constants of further filter elements in the signal path, for example of filters for transmission of the analog measurement variables without interference, can be determined. The sought method must satisfy the following requirements:
as little increase as possible in the calibration effort during manufacture of the converter,
capability for measurement only with the completely constructed and closed appliance in order to avoid complex handling processes and database systems for calibration,
method which can be automated easily, in particular for example no evaluation of current profiles using an oscilloscope,
capability for simple recalibration when replacement parts are required,
capability for simple recalibration in the field, if ageing effects occur, in particular avoiding additional measurement instruments and/or components,
no use of relatively accurate components since these would increase the costs or because the components are not available with the required tight tolerance in the necessary form (SMD).

In the past, the problem of determining the time constants of the voltage filters and, if appropriate, the time constants of further filter elements in the signal path, has been solved by:
use of components with tighter tolerances, associated with the disadvantage of high costs,
use of additional measurement instruments and greater calibration effort, for example by measuring the phase offset between the mains and the comparator input with the aid of an oscilloscope, associated with the disadvantage of a long time being required,
acceptance of the effects of lack of matching associated with the disadvantage of deterioration in the utilization of the converter, its maximum load and its power factor.

In conjunction with a converter according to the invention, with switching without any interruption between fundamental-frequency, unregulated operation and voltage-regulated, clocked operation, the above problem can be solved as described in the following text.

In principle, the circuit design of the converter 10 shown in FIG. 5 for the fundamental-frequency mode corresponds to the traditional circuit design of a voltage-regulated clocked converter, which is also referred to as a three-phase, clocked step-up controller with a regulated intermediate-circuit voltage.

The functions of fundamental-frequency unregulated operation and voltage-regulated clocked operation, for example with pulse-width modulation (PWM), can be provided by the same hardware circuit according to the invention. All that is necessary is to change the time sequence of the control signals for the semiconductor components, corresponding to the operating mode. The respectively required control signals are preferably calculated by software.

The transfer function of an RC element 50 as illustrated in FIG. 9 is described by the Laplace transfer function, as a function of the complex frequency s:

$$\frac{{u}_{A} ( s )}{{u}_{E} ( s )} = \frac{1}{{sR}_{F} {C}_{F} + 1} = \frac{1}{{sT}_{F} + 1} \qquad ( 1 )$$

In this case, the following situation is of particular interest:

s=jω₀=j2π·f_{Mains}, (1′)

That is to say the excitation of the transmission element with a sinusoidal voltage:

$$\frac{{u}_{A} ( {jω}_{0} )}{{u}_{E} ( {jω}_{0} )} A {e}^{j ρ} = \frac{1}{\sqrt{{( {ω}_{0} {R}_{F} {C}_{F} )}^{2} + 1}} {e}^{- j arctan ( {ω}_{0} {R}_{F} {C}_{F} )} \qquad ( 2 )$$

with amplitude A and the phase angle:

Φ=−arctan(ω₀R_{F}C_{F}) (3)

If, for example, a 60° filter is used for a mains frequency of 50 Hz, then, using Φ=Φ₀=−60°, the time constant becomes:

$${T}_{F} = {R}_{F} {C}_{F} = - \frac{tan {Φ}_{F}}{2 π \cdot {f}_{mains}} \approx 5.5 ms \qquad ( 4 )$$

The phase error ΔΦ which occurs in the event of tolerance discrepancies in the components from their nominal values R_{F0} and C_{F0}, is given by:

ΔΦ=arctan(2πfₘₐᵢₙₛ·R_{F}·C_{F})−arctan(2πfₘₐᵢₙₛ·R_{F0}·C_{F0}) (5)

Assuming a normal +/−10% tolerance band for R_{F} and C_{F}, this results, at fₘₐᵢₙₛ=50 Hz, in:

−5.5°≈0.096 rad<ΔΦₘₐₓ<0.079 rad≈4.5° (6)

As is illustrated in FIGS. 7 and 8, even this results in considerable effects on the voltage and current profiles, and thus on the operating characteristics of the converter.

FIG. 10 shows the proposed procedure for determining the actual effective filter time constant. The procedure can be automated, does not require any further measurement components or measurement instruments in addition to the converter, and the measurement duration is in the range <2 s.

First of all, in a first step a) for the time constant of the filter, the nominal value of the components is assumed:

T_{F0}=R_{F0}C_{F0} (7)

On the basis of the schematic diagram illustrated in FIG. 6, the mains angle is determined in step b) (FIG. 10) with the aid of the comparator circuit, first of all using these initialization values, and produces the value Φ_{comp,mains0}, which at this stage allows non-optimized partial-load operation of the converter.

In a third step c) (FIG. 10), the converter is operated in the voltage-regulated step-up controller mode, and the semiconductor switches are driven. In the step-up controller mode, the converter output voltages u_{RYB,Umr} are clocked and are thus in general subject to sufficiently severe disturbances that the comparator circuit no longer produces reliable signals.

A three-phase alternating-current model of the mains system can be used to calculate the mains voltages and thus the mains angle Φ_{mod,mains} on the assumption of sinusoidal alternating variables, however, in a fourth step d) (FIG. 10), for example by means of a circuit 60 as illustrated in FIG. 12. The input variables of the model are in this case the currents and voltages measured in the converter. The estimated mains angle Φ_{mod,mains} as an output variable of the mains model in turn forms the input variable of the PLL for calculation of a stable, filtered mains angle Φ_{PLL,mains}. As a result of discrepancies between Φ_{comp,mains0} and Φₘₐᵢₙₛ, the current regulator initially produces output voltages which lead to control errors in the phase currents. These control differences in the current regulator result in corrected output voltages u_{RYB,Umr} in the subsequent sampling cycles, which in turn lead to a change in the mains angle as estimated by the model. After a stabilization process, the control error of the control regulator is regulated out and the PLL is in the steady state, that is to say Φ_{PLL,mains}≈Φₘₐᵢₙₛ and ΔΦ≈0. The stabilization process is illustrated in the diagram 70 in FIG. 11. By way of example, the steady state can be confirmed by the magnitude of the rate of change of f_{PLL,mains}=Φ_{PLL,mains} being below a limit value.

Now, in step e) (FIG. 10), the drive signals for the semiconductor switches are blocked again, as a result of which the comparator circuit can once again detect the mains angle. In parallel with this, in the sampling clock, the model angle of the mains model is rotated further using the most recently determined frequency:

Φ^{PLL,mains}(k+1)=Φ_{PLL,mains}(k)+2π·f_{PLL,mains}T_{sampling clock} (8)

Since the mains frequency changes only slowly, the phase error, which in this case is in the sub-second range, between the model value and the actual phase angle is negligible.

The second mains angle measurement, which is carried out immediately after pulse blocking, by the comparators produces Φ_{comp,mains1}. The phase correction which is carried out during the PLL stabilization process then results in step f) (FIG. 10), as:

ΔΦₑᵣᵣₒᵣ=Φ_{PLL,mains}−Φ_{comp.mains1} (9)

Using Φ_{F0} as the filter phase, the following expression is obtained for the corrected, instantaneously acting time constant T_{F, corr}, for nominal values and frequency fₘₐᵢₙₛ:

$$\begin{matrix}\begin{matrix}{T}_{F , korr} = {R}_{F , korr} {C}_{F , korr} \\ = \frac{tan ( Δ {Φ}_{error} - {Φ}_{F 0} )}{2 π \cdot {f}_{Mains}} \\ = \frac{tan ( {ΔΦ}_{error} + arctan ( 2 π \cdot {f}_{Mains} {R}_{F 0} {C}_{F 0} ) )}{2 π \cdot {f}_{Mains}}\end{matrix} & ( 10 )\end{matrix}$$

If the mains frequency is f_{mains,operation} during subsequent operation after the matching process, it follows from equation (3) for the entire phase angle which is to be corrected of the actual RC filter with a time constant T_{F,corr}:

Φ_{corr}=−arctan(2π·f_{mains,operation}·T_{F,corr}) (11)

The special case in which f_{mains,operation}=fₘₐᵢₙₛ results in the simplification:

Φ_{corr}=−ΔΦₑᵣᵣₒᵣ+Φ_{F0} (12)

The converter changes to the fundamental-frequency, unregulated mode again in step g) (FIG. 10).

It should be noted that, instead of the second mains angle determination with the difference angle subsequently being calculated, it is also possible to integrate all the mains angle changes during the standardization of the mains model and of the PLL. However, since in some circumstances the stabilization process may take several seconds, actual phase errors resulting from mains frequency changes would also be included in the correction value for the filter time constant when using this procedure, leading to increased measurement accuracy.

The method described above can be used to measure the time constant of an RC filter in order to detect the mains angle for converters. The method is distinguished by the following characteristics:
high accuracy (measurement error <1°), suitable for optimization of the fundamental-frequency operating mode (see FIG. 8 above)—thus resulting in optimum utilization and load capability of the converter,
no additional components or measurement instruments required,
can be automated and, for example, can be integrated in the setting-up procedure for the converter,
fast (stabilization duration of the PLL in general <2 s),
the overall phase delay of all the filters in the signal path is detected for mains angle determination,
no additional calibration effort during converter manufacture,
simple recalibration if replacement parts are required,
simple, or else automatic, recalibration in the field if servicing is required,
no special components required for the filter circuits,
cost-effective.

The method as described above for determining the filter time constants T_{F,corr} can be used in particular in conjunction with a converter according to the invention with switching without any interruption between fundamental-frequency unregulated operation and voltage-regulated clocked operation.

1.-11. (canceled)

12. A power mains converter, comprising:
means for operating the converter in a fundamental-frequency unregulated operating mode,
means for operating the converter in a clocked, voltage-regulated operating mode,
means for detecting parameters identifying at least one of an instantaneous operating point and an instantaneous power mains condition,
means for selecting a suitable operating mode based on the detected parameters, and
means for switching the operating mode of the converter from an instantaneous operating mode to the suitable operating mode, without interruption, if the instantaneous operating mode is not the suitable operating mode,
wherein the means for operating the converter operate the converter both when power is received from the power mains and when power is supplied to the power mains.

13. The converter of claim 12, wherein the means for operating the converter in the fundamental-frequency unregulated mode and the means for operating the converter in the clocked voltage-regulated mode are arranged in a converter topology configured to operate in both operating modes, the converter further comprising circuit components configured for both operating modes, and at least one of control hardware and control software switchable to both operating modes.

14. The converter of claim 13, wherein the converter topology comprises an IGBT-B6 bridge.

15. The converter of claim 13, wherein the control hardware or control software, or both, comprise a control ASIC and a configuration register, wherein the control ASIC is switched by a configuration of the configuration register.

16. The converter of claim 15, wherein the means for switching the converter comprise at least one of hardware and software configured to:
access the configuration register during operation of the converter, or
access a system sequence controller and initialization routines of at least one of the control hardware and control software for on-the-fly activation of the selected suitable operating mode, or
block pulses for one sampling clock cycle during switching,
or a combination thereof.

17. A method for switching a power mains converter, without interruption, between a fundamental-frequency unregulated operating mode and a clocked, voltage-regulated operating mode, both when power is received from the power mains and when power is supplied to the power mains system, comprising the steps of:
detecting an instantaneous operating mode of the converter,
detecting parameters identifying at least one of an instantaneous operating point and an instantaneous power mains condition,
selecting a suitable operating mode based on the detected parameters, and
switching the operating mode of the converter from an instantaneous operating mode to the suitable operating mode, if the instantaneous operating mode is not the suitable operating mode, or
continuing the instantaneous operating mode if the instantaneous operating mode is the suitable operating mode.

18. The method of claim 17, wherein detecting parameters comprises reading or latching a configuration register in an ASIC in conjunction with other control registers.

19. The method of claim 17, wherein switching the operating mode comprises blocking pulses during one sampling clock cycle.

20. The method of claims 17, wherein the detected parameters include a power mains voltage or an intermediate-circuit voltage of the converter, or both.

21. The method of claim 17, wherein switching from the fundamental-frequency unregulated mode to the clocked voltage-regulated mode comprises changing an intermediate-circuit voltage along a ramp to a set value.

22. The method of claim 17, wherein switching from the clocked voltage-regulated mode to the fundamental-frequency unregulated mode comprises regulating an intermediate-circuit voltage to a rectifier value for the fundamental-frequency unregulated mode.
